(19) United States
(12) Patent Application Publication
(10) Pub. No.: US 2026/0179589 A1
(43) Pub. Date: Jun. 25, 2026

(54) STAND AND KEYBOARD INSTRUMENT SET

(71) Applicant: CASIO COMPUTER CO., LTD., Tokyo (JP)

(72) Inventors: Naoto IMAMURA, Tokyo (JP); Hiroshi IKEMOTO, Tokyo (JP); Otoya SAKAI, Tokyo (JP); Takahiro MORIYA, Tokyo (JP)

(73) Assignee: CASIO COMPUTER CO., LTD., Tokyo (JP)

(21) Appl. No.: 19/426,232

(22) Filed: Dec. 19, 2025

(30) Foreign Application Priority Data
Dec. 20, 2024 (JP) 2024-225023

(51) Int. Cl. G10G 5/00; G10H 1/34

(52) U.S. Cl. CPC G10G 5/005; G10H 1/348; G10H 2220/221; G10H 2220/265

(57) ABSTRACT

A stand includes: legs that support a front side of a keyboard instrument; a pedal frame disposed at a back side of the keyboard instrument; and a pedal device fixed to the pedal frame. The pedal frame supports the back side of the keyboard instrument.

### CROSS-REFERENCE TO RELATED APPLICATIONS

This application is based upon and claims the benefit of priority from the prior Japanese Patent Application No. 2024-225023, filed on December 20, 2024, the entire contents of which are incorporated herein by reference.

### BACKGROUND OF THE INVENTION

### TECHNICAL FIELD

The present disclosure relates to a stand for a keyboard instrument and a keyboard instrument set including the stand.

### DESCRIPTION OF RELATED ART

A known stand for a keyboard instrument has four legs. For example, according to Japanese Unexamined Patent Application Publication No. 2023-157063, a four-leg stand includes a horizontal member on which the keyboard instrument is placed; connectors provided at both ends of the horizontal member; and front legs and back legs connected to the respective connectors.

### SUMMARY OF THE INVENTION

According to the present disclosure, a stand includes: legs that support a front side of a keyboard instrument; a pedal frame disposed at a back side of the keyboard instrument; and a pedal device fixed to the pedal frame, wherein the pedal frame supports the back side of the keyboard instrument.

### BRIEF DESCRIPTION OF DRAWINGS

FIG. 1 is a perspective view of a keyboard instrument set according to an embodiment of the present disclosure.

FIG. 2 is a front view of the keyboard instrument set shown in FIG. 1.

FIG. 3 is a plan view of the keyboard instrument set shown in FIG. 1.

FIG. 4 is a lateral view of the keyboard instrument set shown in FIG. 1.

FIG. 5 is a perspective view of a stand of the keyboard instrument set shown in FIG. 1.

FIG. 6 is a perspective view of the stand of FIG. 5 viewed from diagonally behind and to the right.

FIG. 7 is an enlarged view of main part at the foreground side of the stand in FIG. 6.

FIG. 8 is an exploded perspective view of main part of a connector of the stand in FIG. 7, wherein a leg attachment part and a leg at the connector are enlarged.

### DETAILED DESCRIPTION

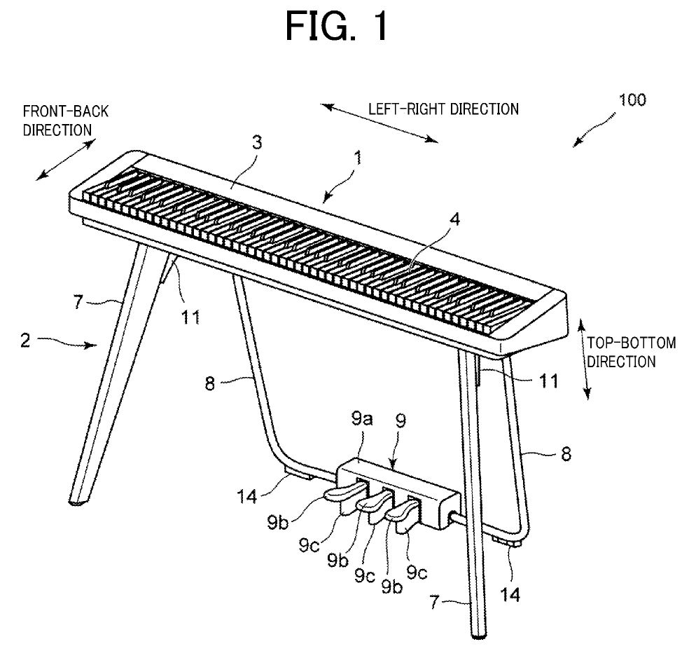

Hereinafter, an embodiment of the present disclosure applied to a keyboard instrument set is described with reference to FIG. 1 to FIG. 8. A keyboard instrument set 100 includes a keyboard instrument 1 and a stand 2, as shown in FIG. 1 to FIG. 4. The keyboard instrument 1 includes an instrument case 3 that is long in the widthwise direction (left-right direction). The instrument case 3 is provided with a keyboard 4. The keyboard 4 includes multiple white keys and black keys arranged in the long-side direction (left-right direction).

In the present disclosure, the left-right direction refers to the direction to the left and to the right of a position where a player stands in playing the keyboard instrument 1. Regarding the top-bottom direction (up-down direction), the top surface of the keyboard instrument 1 is defined as the surface on which the keyboard 4 is provided; and the bottom surface of the keyboard instrument 1 is defined as the surface opposite the top surface. Regarding the front-back direction, the front side is the player's side, and the back side is the side opposite the front side.

As shown in FIG. 1 to FIG. 5, the stand 2 includes a horizontal member 5, two connectors 6, two legs 7, a pedal frame 8, and a pedal device 9. The horizontal member 5 has a rectangular tubular shape that is long in the widthwise direction (left-right direction). The keyboard instrument 1 is placed on the horizontal member 5. The two connectors 6 are provided at both ends in the widthwise direction (left-right direction) of the horizontal member 5. The two legs 7 are attached to the respective connectors 6 and support the front side of the keyboard instrument 1. The pedal frame 8 is attached to the connectors 6 at both sides and supports the back side of the keyboard instrument 1. The pedal device 9 is fixed to the pedal frame 8.

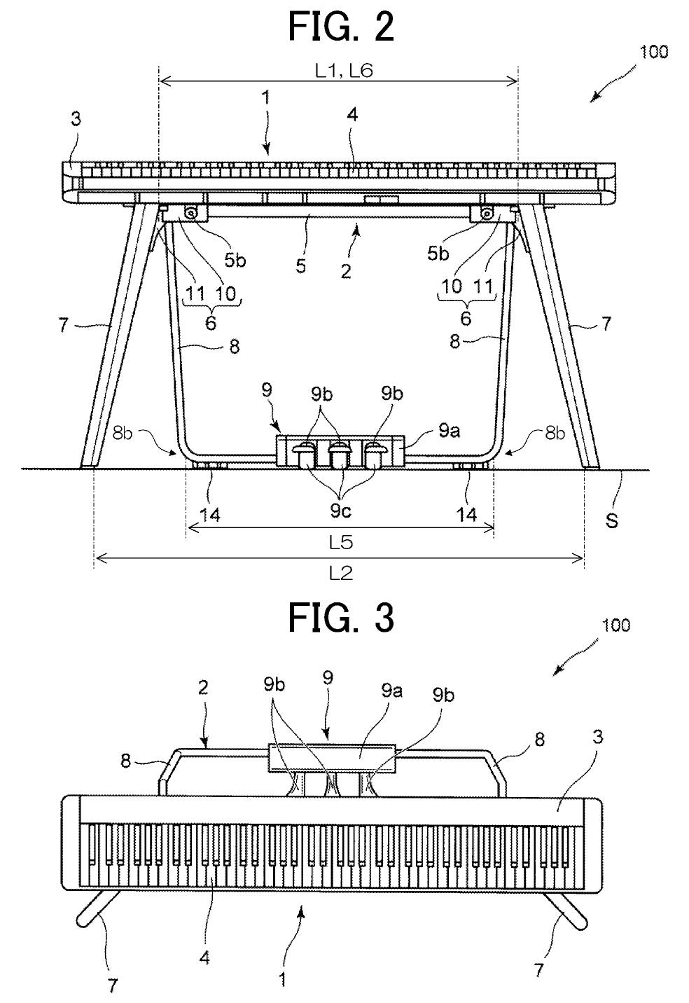

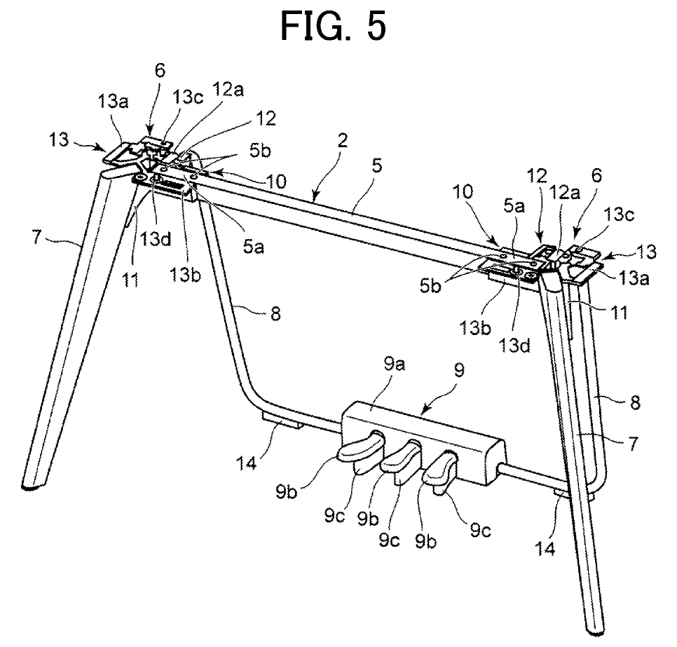

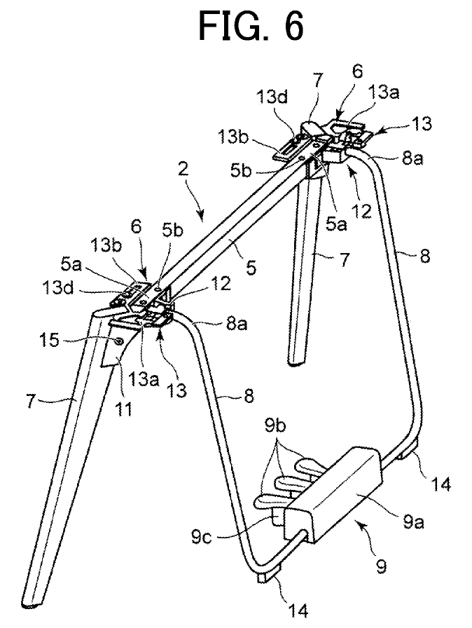

As shown in FIG. 5 to FIG. 8, each of the two connectors 6 includes: a horizontal-member attachment part 10 to which an end part 5a in the left-right direction of the horizontal member 5 is attached; a leg attachment part 11 to which the upper part of the leg 7 is attached; a frame attachment part 12 to which the upper end part of the pedal frame 8 is attached; and an instrument setting part 13 that determines the position of the bottom surface of the keyboard instrument 1 and on which the keyboard instrument 1 is mounted. The end parts 5a in the widthwise (left-right) direction of the horizontal member 5 are inserted into the respective horizontal-member attachment parts 10 from above, and multiple screws 5b (see FIG. 2 and FIG. 6) are screwed on the top surface, the bottom surface, and the lateral surfaces of the end parts 5a. Thus, the horizontal-member attachment parts 10 are attached to the horizontal member 5.

The leg attachment parts 11 are L-shaped, as illustrated in FIG. 5 to FIG. 8. Each of the leg attachment parts 11 includes a first receiving surface 11a and a second receiving surface 11b that are perpendicular to each other. The leg 7 is attached to the first receiving surface 11a and the second receiving surface 11b. The first receiving surface 11a of the leg attachment part 11 extends diagonally downward from the inside to the outside of the keyboard instrument 1. The second receiving surface 11b of the leg attachment part 11 extends diagonally downward and forward in the front-back direction (short-side direction) of the keyboard instrument 1. The first receiving surface 11a may not be perpendicular to the second receiving surface 11b. The present disclosure also includes a case where the first receiving surface 11a simply crosses the second receiving surface 11b.

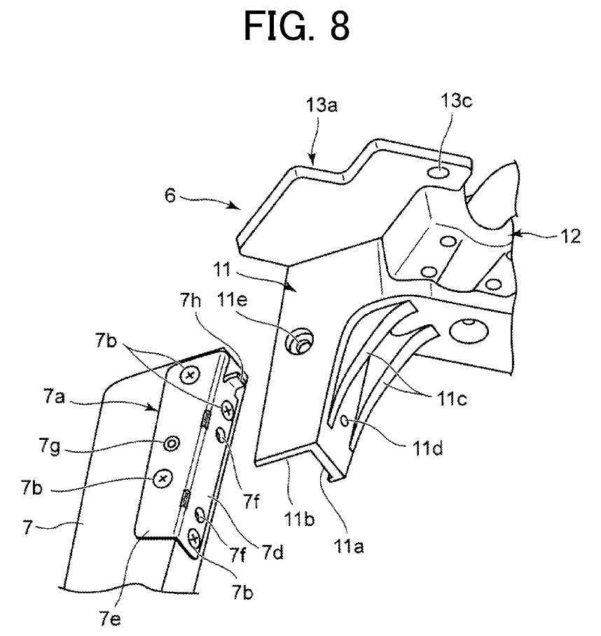

In this case, an external surface opposite the first receiving surface 11a of the leg attachment part 11 has ribs 11c along the top-bottom direction, as illustrated in FIG. 8. The ribs 11c are reinforcement members. At the upper and lower parts of the first receiving surface 11a (only the lower part is illustrated in FIG. 8), first attachment holes 11d are formed between the ribs 11c as the reinforcement members. At the central part in the top-bottom direction of the second receiving surface 11b, a second attachment hole 11e is formed. An upper corner of each of the legs 7 is provided with an L-shaped reinforcement metal part 7a. The reinforcement metal part 7a is attached to the upper corner of the leg 7 by screws 7b. The reinforcement metal part 7a faces the first receiving surface 11a and the second receiving surface 11b, which are perpendicular to each other, of the leg attachment part 11. The reinforcement members are not limited to ribs. Any member having the reinforcement effect is applicable, such as a stay, a bracket, or a stiffener.

The reinforcement metal part 7a has a first attachment surface 7d and a second attachment surface 7e, as illustrated in FIG. 8. The first attachment surface 7d faces the first receiving surface 11a of the leg attachment part 11, and the second attachment surface 7e faces the second receiving surface 11b of the leg attachment part 11. The first attachment surface 7d of the reinforcement metal part 7a has two first screw holes 7f at the upper and lower parts. The two first screw holes 7f correspond to the two first attachment holes 11d of the first receiving surface 11a of the leg attachment part 11. The upper end part of the first attachment surface 7d of the reinforcement metal part 7a has an engaging protrusion 7h that engages with a non-illustrated engaging recess formed in the first receiving surface 11a of the leg attachment part 11. The second attachment surface 7e of the reinforcement metal part 7a has a second screw hole 7g. The second screw hole 7g corresponds to the second attachment hole 11e of the second receiving surface 11b of the leg attachment part 11.

As illustrated in FIG. 8, when the reinforcement metal part 7a at the upper part of each leg 7 is arranged inside the leg attachment part 11 of the connector 6, the first attachment surface 7d and the second attachment surface 7e of the reinforcement metal part 7a, which are perpendicular to each other, face the first receiving surface 11a and the second receiving surface 11b of the leg attachment part 11, which are perpendicular to each other. Thus, the reinforcement metal part 7a is covered by the first receiving surface 11a and the second receiving surface 11b, which are perpendicular to each other, of the leg attachment part 11 of the connector 6. The reinforcement metal part 7a is therefore hidden and invisible from outside. In this case, the two first screw holes 7f of the reinforcement metal part 7a correspond to the two first attachment holes 11d (only one of them is illustrated) of the first receiving surface 11a; and the second screw hole 7g of the reinforcement metal part 7a corresponds to the second attachment hole 11e of the second receiving surface 11b. The engaging protrusion 7h of the reinforcement metal part 7a is placed on the non-illustrated engaging recess of the first receiving surface 11a and thereby engages with the engaging recess.

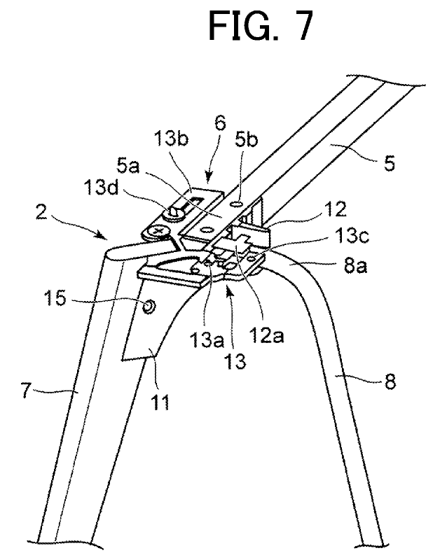

As illustrated in FIG. 7 and FIG. 8, according to the leg 7, two screws as fastening members (not illustrated) are inserted through the first attachment holes 11d of the first receiving surface 11a and screwed to the two first screw holes 7f of the first attachment surface 7d of the reinforcement metal part 7a; and the other screw 15 (see FIG. 7) is inserted through the second attachment hole 11e of the second receiving surface 11b and screwed to the second screw hole 7g of the second attachment surface 7e of the reinforcement metal part 7a. Thus, the non-illustrated two screws and the other screw 15 are screwed to the reinforcement metal part 7a of the leg 7, so that the leg 7 is attached to the leg attachment part 11 of the connector 6.

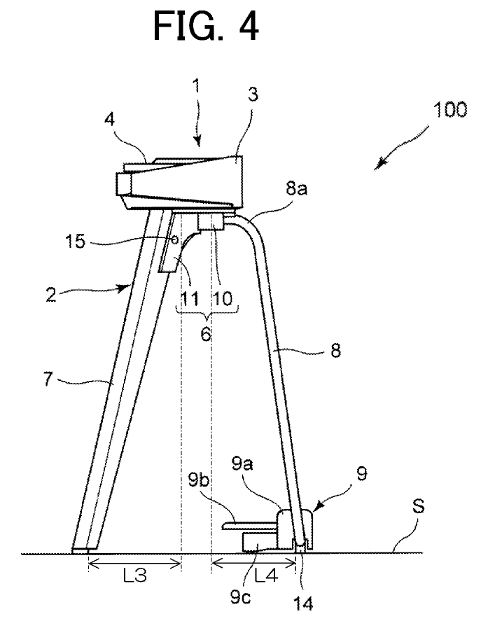

As illustrated in FIG. 5 to FIG. 8, the two legs 7 are attached to the leg attachment parts 11 of the connectors 6, which are provided at both ends of the horizontal member 5, by the non-illustrated two screws and the other screw 15. Accordingly, as illustrated in FIG. 3 and FIG. 4, the legs 7 extend diagonally downward, outward, and forward in the front-back direction (short-side direction) of the keyboard instrument 1. Thus, the legs 7 spread outward and forward with respect to the keyboard instrument 1.

The frame attachment part 12 of the connector 6 includes a pressing metal part 12a that presses and fixes the upper end of the pedal frame 8, as illustrated in FIG. 5 to FIG. 7. The pressing metal part 12a is attached to the frame attachment part 12 with non-illustrated screws in the state where the pressing metal part 12a positions and presses the upper end of the pedal frame 8 with respect to the frame attachment part 12. In this case, the pedal frame 8 consists of two large bars. In a front view of the keyboard instrument 1 as illustrated in FIG. 2, the two bars of the pedal frame 8 extend upward from both ends in the long-side direction of the pedal device 9 so as to form a substantially inverted trapezoid shape. In other words, the two bars of the pedal frame 8 spread upward. As illustrated in FIG. 3 and FIG. 4, the pedal frame 8 is disposed behind the legs 7 and extends diagonally downward and backward in the front-back (short-side) direction of the keyboard instrument 1.

Further, the pedal frame 8 is provided with non-slip members 14 (contact members) at two positions at both sides in the left-right direction (long-side direction) of the pedal device 9. The non-slip members 14 are in contact with the installation surface S on which the stand 2 is installed and prevents the stand 2 from slipping. The non-slip members 14 are not necessary for the pedal frame 8. The bottom of the horizontal bar part of the pedal frame 8 may be in contact with the installation surface S.

As illustrated in FIG. 1 to FIG. 5, the pedal device 9 includes: a box-shaped device body 9a that is long in the widthwise (long-side) direction of the keyboard instrument 1; and three pedals 9b that are arranged in the widthwise (long-side) direction of the device body 9a and project forward from the device body 9a. Below the respective three pedals 9b, projections 9c are provided that extend forward from the device body 9a. The projections 9c are provided with a non-illustrated installation adjustment member that adjusts the contact with the installation surface S.

The instrument setting parts 13 of the two connectors 6, on which the keyboard instrument 1 is mounted, each include: a front setting part 13a that extends toward the front side of the keyboard instrument 1; and a lateral setting part 13b that extends in the widthwise (long-side) direction of the keyboard instrument 1, as illustrated in FIG. 5 to FIG. 8. The two front setting parts 13a each have a fixing hole 13c for screwing the bottom surface at the end of the keyboard instrument 1 in the long-side direction. The two lateral setting parts 13b each have a positioning pin 13d for positioning the bottom surface of the keyboard instrument 1.

Hereinafter, how to assembly the keyboard instrument set 100 is described. Firstly, the stand 2 is assembled. The connectors 6 are attached to both end parts in the widthwise (left-right) direction of the horizontal member 5. Specifically, the end parts 5a at both ends of the horizontal member 5 are fitted to the horizontal-member attachment parts 10 of the respective two connectors 6 from above. Then, screws 5b are screwed to the upper surface, the bottom surface, and the lateral surfaces of the end parts 5a at both ends of the horizontal member 5. Thus, the connectors 6 are attached to the horizontal member 5. In this state, the pedal frame 8 is attached to the frame attachment parts 12 of the connectors 6, which have been attached to the horizontal member 5.

Herein, the pedal device 9 has been attached to the pedal frame 8 beforehand; and the non-slip members 14 have been attached to both side parts of the pedal frame 8 at both sides of the pedal device 9 beforehand. The pedal frame 8 is then laid on the installation surface S (e.g., floor) such that the upper ends 8a at both ends of the pedal frame 8 face upward. In this state, the frame attachment parts 12 of the two connectors 6 are attached to the upper ends 8a at both ends of the pedal frame 8. Herein, the upper ends 8a of the pedal frame 8 are positioned with respect to the frame attachment parts 12 of the connectors 6 and pressed with the pressing metal parts 12a. In this state, the pressing metal parts 12a are attached to the frame attachment parts 12 with non-illustrated screws.

When the horizontal member 5 is attached to the pedal frame 8 via the two connectors 6 in the state where the pedal frame 8 is laid on the installation surface S (e.g., floor), the leg attachment parts 11 of the two connectors 6 tilt diagonally upward. In this state, the legs 7 are attached to the leg attachment parts 11 of the respective two connectors 6, which have been attached to both ends of the horizontal member 5. Herein, the L-shaped reinforcement metal parts 7a have been attached to the upper corners of the respective legs 7 with screws 7b beforehand.

In this state, the engaging protrusion 7h of the L-shaped reinforcement metal part 7a, which has been attached to the upper part of each leg 7 beforehand, is placed on and engages with the engaging recess of the first receiving surface 11a, so that the position of the reinforcement metal part 7a is substantially determined. In this state, the reinforcement metal part 7a is positioned inside the L-shaped leg attachment part 11 of the connector 6. Accordingly, the first attachment surface 7d and the second attachment surface 7e of the reinforcement metal part 7a, which are perpendicular to each other, face the first receiving surface 11a and the second receiving surface 11b of the leg attachment part 11, which are perpendicular to each other. In this state, the two first screw holes 7f of the reinforcement metal part 7a correspond to the two first attachment holes 11d of the first receiving surface 11a; and the second screw hole 7g of the reinforcement metal part 7a corresponds to the second attachment hole 11e of the second receiving surface 11b. Thus, the reinforcement metal part 7a is covered by the first receiving surface 11a and the second receiving surface 11b (perpendicular to each other) of the leg attachment part 11 of the connector 6, thereby being hidden and invisible from outside.

Then, non-illustrated two screws (fastening members) are inserted through the first attachment holes 11d of the first receiving surface 11a and screwed into the two first screw holes 7f formed on the first attachment surface 7d of the reinforcement metal part 7a. Further, the other screw 15 is inserted through the second attachment hole 11e of the second receiving surface 11b and screwed into the second screw hole 7g. By screwing the non-illustrated two screws and the other screw 15, the leg 7 is attached to the leg attachment part 11 of the connector 6. Thus, the stand 2, which supports the front and the back of the keyboard instrument 1 by the two legs 7 and the pedal frame 8, is assembled.

In this state, the stand 2 is erected on the installation surface S (e.g., floor) with the two legs 7 and the pedal frame 8. As shown in FIG. 3 and FIG. 4, the two legs 7 extend downward in the outward direction of the keyboard instrument 1 and the forward direction in the front-back (short-side) direction of the keyboard instrument 1. Thus, the legs 7 spreads outward and forward with respect to the keyboard instrument 1. Specifically, as shown in FIG. 2, the distance L2 between the two legs 7 at the installation surface S side (e.g., floor side) is greater than the distance L1 between the two legs 7 at the keyboard side. Further, as shown in FIG. 4, when viewed in the left-right direction, there is a distance L3 between the leg 7 at the keyboard side and the leg 7 at the installation surface S side (floor side). Thus, the legs 7 extend forward with respect to the keyboard instrument 1. Thus, the two legs 7 spread diagonally forward with respect to the keyboard instrument 1 and support the front side of the keyboard instrument 1. Herein, the pedal frame 8, which consists of two bars, is arranged behind the legs 7, extends backward with respect to the keyboard instrument 1, and supports the back side of the keyboard instrument 1. Such a stand 2 has a stable structure and is less likely to fall down when the keyboard instrument 1 is pressed from the front side.

Both ends of the bottom surface of the keyboard instrument 1 in the left-right (long-side) direction are placed on the instrument setting parts 13 of the two connectors 6 of the stand 2. The positions of both ends of the bottom surface of the keyboard instrument 1 in the left-right direction are determined by the positioning pins 13d provided to the lateral setting parts 13b of the respective two instrument setting parts 13. In this state, non-illustrated screws are inserted through the fixing holes 13c of the respective two front setting parts 13a from below the keyboard instrument 1 and screwed into the bottom surface of the keyboard instrument 1. Thus, the keyboard instrument 1 is attached to the stand 2. In this state, the contact state of the pedal device 9 with respect to the installation surface S is adjusted by a non-illustrated installation adjustment member of the pedal device 9. Thus, the keyboard instrument set 100 is assembled.

As described above, the stand 2 of the keyboard instrument set 100 includes: the legs 7 that support the front side of the keyboard instrument 1; the pedal frame 8 disposed at the back side of the keyboard instrument 1; and the pedal device 9 fixed to the pedal frame 8. The pedal frame 8 supports the back side of the keyboard instrument 1. For example, according to a four-leg stand described in JP 2023-157063A, the stand has many parts (e.g., screws) for the four legs and has a complex structure. Such a stand requires complicated assembly work. On the other hand, according to the stand 2 of the keyboard instrument set 100 of the present disclosure, the number of parts can be reduced.

Specifically, the stand 2 of the keyboard instrument set 100 uses the pedal frame 8 as a back-side leg. This eliminates the need for back-side legs as separate parts and reduces the number of parts. Further, since the connectors 6 do not need leg attachment parts for attaching the back-side legs, the structure is simplified. Accordingly, assembly work is simplified, and productivity is increased.

Further, the stand 2 of the keyboard instrument set 100 includes two legs 7. The two legs 7 are disposed at the front side of the keyboard instrument 1 and arranged next to each other in the left-right (long-side) direction of the keyboard instrument 1. The legs 7 extend outward with respect to the keyboard instrument 1. Such two legs 7 can certainly, stably and appropriately support the front side of the keyboard instrument 1.

Further, according to the stand 2 of the keyboard instrument set 100, the pedal frame 8 is positioned behind the legs 7. The pedal frame 8 extends backward with respect to the keyboard instrument 1. Such a pedal frame 8 can certainly, stably and appropriately support the back side of the keyboard instrument 1. According to the stand 2 of the keyboard instrument set 100, the two legs 7 support the front side of the keyboard instrument 1, and the pedal frame 8 supports the back side of the keyboard instrument 1. Such legs 7 and pedal frame 8 can certainly, stably and appropriately support the keyboard instrument 1.

According to the stand 2 of the keyboard instrument set 100, the pedal frame 8 consists of two bars. When viewed from the front of the keyboard instrument 1, the two bars extend upward from both ends in the left-right (long-side) direction of the pedal device 9 to form a substantially inverted trapezoid shape. Such a pedal frame 8 can minimize a contact area for securing the stability of the keyboard instrument set 100 installed on the installation surface S (e.g., floor). Such a pedal frame 8 contributes to reducing the installation space. Further, the pedal frame 8 extends backward with respect to the keyboard instrument 1. As illustrated in FIG. 4, when viewed in the left-right direction, there is a distance L4 between the pedal frame 8 at the keyboard side and the pedal frame 8 at the installation surface S side (e.g., floor). Thus, the pedal frame 8 extends backward with respect to the keyboard instrument 1 and supports the back side of the keyboard instrument 1. Such a stand has a stable structure and is less likely to fall when the keyboard instrument 1 is pressed from the back side.

Further, according to the stand 2 of the keyboard instrument set 100, the pedal frame 8 includes the non-slip members 14 (contact members) to be in contact with the installation surface S. The non-slip members 14 can prevent the pedal frame 8 from slipping on the installation surface S and scratching the installation surface S.

Further, as illustrated in FIG. 2, according to the stand 2 of the keyboard instrument set 100, in a plan view from the front, the distance L5 between both ends 8b of the horizontal bar part of the pedal frame 8 is shorter than the distance L6 between both top ends 8a of the pedal frame 8. The distance of the two bars that constitute the pedal frame 8 increases from L5 to L6 toward the keyboard instrument side, so that the distance L6 (the width of the pedal frame 8 at the keyboard instrument side) is substantially equal to the distance L1 of the two legs 7 at the keyboard instrument side.Such a pedal frame 8 has a sufficient width and can support the back side of the keyboard instrument 1 stably, certainly and appropriately. Further, such a pedal frame 8 is less likely to be in contact with the knees of the player playing the keyboard instrument 1.

In the above-described embodiment, the pedal frame 8 has a substantially inverted trapezoid shape. However, the present disclosure is not limited to this. The pedal frame 8 may have a square or rectangular shape, for example.

The procedure of assembling the keyboard instrument set 100 of the present disclosure is not limited to the above embodiment. The legs 7 may be assembled first, and thereafter the pedal frame 8 may be attached.

In the above embodiment, the stand 2 is applied to the keyboard instrument 1. The present disclosure is not only for the keyboard instrument 1 but is also applicable to a koto (zither-like Japanese musical instrument), a dulcimer, a DJ controller, or a MIDI controller, for example.

1. A stand comprising:
legs that support a front side of a keyboard instrument;
a pedal frame disposed at a back side of the keyboard instrument; and
a pedal device fixed to the pedal frame,
wherein the pedal frame supports the back side of the keyboard instrument.

2. The stand according to claim 1, wherein:
the legs include at least two legs that are disposed at the front side of the keyboard instrument and arranged next to each other in a long-side direction of the keyboard instrument, and
a distance between the legs at an installation surface side is greater than a distance between the legs at a keyboard instrument side.

3. The stand according to claim 1, wherein:
the pedal frame is disposed at the back side of the legs, and
the pedal frame extends backward with respect to the keyboard instrument from a keyboard instrument side of the pedal frame.

4. The stand according to claim 1, wherein:
the pedal frame includes two bars, and
in a front view of the keyboard instrument, the two bars extend from both sides in a long-side direction of the pedal device so as to spread upward.

5. The stand according to claim 1, wherein the pedal device is provided to a horizontal bar part of the pedal frame.

6. The stand according to claim 1, wherein the pedal frame includes a contact member to be in contact with an installation surface.

7. The stand according to claim 6, wherein the contact member is provided at a bottom of a horizontal bar part of the pedal frame, the horizontal bar part extending from both sides of the pedal device.

8. The stand according to claim 1, wherein in a plan view from the front side, a width of the pedal frame at a keyboard instrument side is substantially equal to a distance between the legs at a keyboard instrument side.

9. A keyboard instrument set comprising the stand according to claim 1.
